(19) United States
(12) Patent Application Publication
(10) Pub. No.: US 2024/0124802 A1
(43) Pub. Date: Apr. 18, 2024

(54) TECHNIQUES FOR REQUESTING INTER-UE COORDINATION MESSAGES FOR SIDELINK

(71) Applicant: QUALCOMM Incorporated, San Diego, CA (US)

(72) Inventors: Tugcan AKTAS, La Jolla, CA (US); Seyedkianoush HOSSEINI, San Diego, CA (US); Tien Viet NGUYEN, Bridgewater, NJ (US); Gabi SARKIS, San Diego, CA (US)

(21) Appl. No.: 18/392,360

(22) Filed: Dec. 21, 2023

Related U.S. Application Data
(63) Continuation of application No. 17/685,684, filed on Mar. 3, 2022.
(60) Provisional application No. 63/187,343, filed on May 11, 2021.

(51) Int. Cl. C11D 3/00; A23L 5/20; B08B 9/032; B08B 9/08; B67D 1/07; C11D 3/04; C11D 3/20; C11D 3/34; C11D 3/36; C11D 3/40; B08B 9/027

(52) U.S. Cl. CPC C11D 3/0042; A23L 5/20; B08B 9/032; B08B 9/08; B67D 1/07; C11D 3/044; C11D 3/2086; C11D 3/3409; C11D 3/364; C11D 3/40; A23V 2002/00; B08B 9/027; B67D 2001/075; C11D 2111/20; C11D 2111/44

(57) ABSTRACT

Certain aspects of the present disclosure provide techniques for requesting inter-UE coordination messages for sidelink communications. In some cases, a method for wireless communications by a first user equipment (UE), include sending a first sidelink transmission to at least one second UE to trigger the second UE to transmit a report regarding sidelink resource availability and monitoring for a second sidelink transmission from the second UE after sending the first sidelink transmission.

### CROSS-REFERENCE TO RELATED APPLICATIONS

This application is a continuation of and claims priority to U.S. patent application Ser. No. 17/658,684, filed Apr. 11, 2022, which claims benefit of and priority to U.S. Provisional Application No. 63/187,343 filed May 11, 2021, each of which are incorporated herein by reference herein in their entirety as if fully set forth below and for all applicable purposes.

### BACKGROUND

### Field of the Disclosure

Aspects of the present disclosure relate to wireless communications, and more particularly, to enhancements for device-to-device sidelink communication based on sharing of resource reservation information.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Sidelink communications are communications from one UE to another UE. As the demand for mobile broadband access continues to increase, there exists a need for further improvements in NR and LTE technology, including improvements to sidelink communications. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. After reading the section entitled “Detailed Description” one will understand how the features of this disclosure provide advantages that include improved device-to-device communications in a wireless network.

Certain aspects of this disclosure provide a method for wireless communications by a first user equipment (UE). The method generally includes sending a first sidelink transmission to at least one second UE to trigger the second UE to transmit a report regarding sidelink resource availability and monitoring for a second sidelink transmission from the second UE after sending the first sidelink transmission.

Certain aspects of this disclosure provide a method for wireless communications by a second user equipment (UE). The method generally includes receiving, from a second UE, resource reservation information indicating a reservation of a future resource by at least a third UE; and taking one or more actions based on the resource reservation information.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3A is a diagram illustrating an example physical architecture of a distributed RAN, in accordance with certain aspects of the present disclosure.

FIG. 3B is a diagram illustrating an example disaggregated base station (BS) architecture, in accordance with certain aspects of the present disclosure.

FIG. 4 is a block diagram conceptually illustrating a design of an example BS and an example user equipment (UE), in accordance with certain aspects of the present disclosure.

FIGS. 5A and 5B show diagrammatic representations of example vehicle to everything (V2X) systems, in accordance with certain aspects of the present disclosure.

FIG. 6 illustrates an example allocation of a resource pool for sidelink communications, in accordance with certain aspects of the present disclosure.

FIG. 7 is an example resource pool for sidelink communication, in accordance with certain aspects of the present disclosure.

FIGS. 8A and 8B illustrate two modes of sidelink communication, in accordance with certain aspects of the present disclosure.

FIG. 9 illustrates an example sensing window and a resource selection window, in accordance with certain aspects of the present disclosure.

FIG. 10 illustrates an example of coordination between UEs (e.g., inter-UE coordination), in accordance with certain aspects of the present disclosure.

FIG. 11 illustrates an example of a possible inter-UE coordination report, in accordance with certain aspects of the present disclosure.

FIG. 12 illustrates an example report and corresponding scheduling decisions, in accordance with certain aspects of the present disclosure.

FIG. 13 illustrates an example resource configuration for inter-UE coordination requests and reporting, in accordance with certain aspects of the present disclosure.

FIG. 14 illustrates example operations for wireless communications by a first UE, in accordance with certain aspects of the present disclosure.

FIG. 15 illustrates example operations for wireless communications by a second UE, in accordance with certain aspects of the present disclosure.

FIGS. 16A-16B illustrate examples of inter-UE coordination, in accordance with certain aspects of the present disclosure.

FIGS. 17 and 18 illustrate communications devices that may include various components configured to perform the operations illustrated in FIGS. 14 and 15, respectively, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to enhancements for device-to-device sidelink communications based on efficient inter-UE coordination that involves requests for resource reservation information.

For example, a first UE may send a sidelink message to trigger (request) the second UE to transmit a report regarding sidelink resource availability from the second UE's perspective. As an alternative to frequent periodic reporting, the request-based reporting techniques described herein may be adapted to traffic patterns of a UE (e.g., whether aperiodic or periodic with large periodicity). As a result, the techniques described herein may help conserve resources, avoid congestion on a shared reporting channel, and improve reliability for sidelink transmissions.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTIs) to meet respective quality of service (QoS) requirements. In addition, these services may co-exist in the same subframe.

### Example Wireless Communication Network

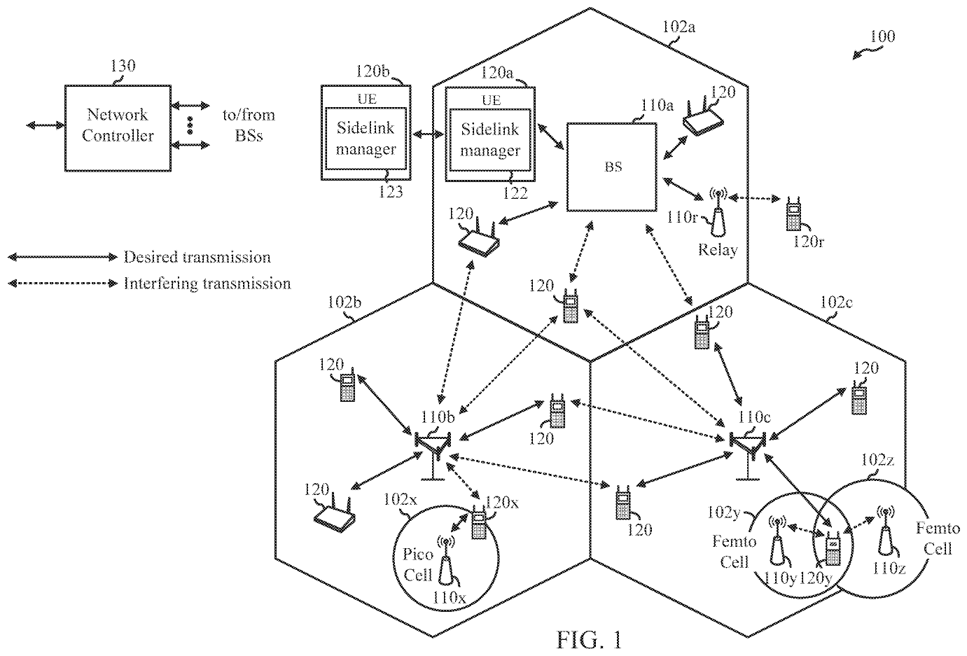

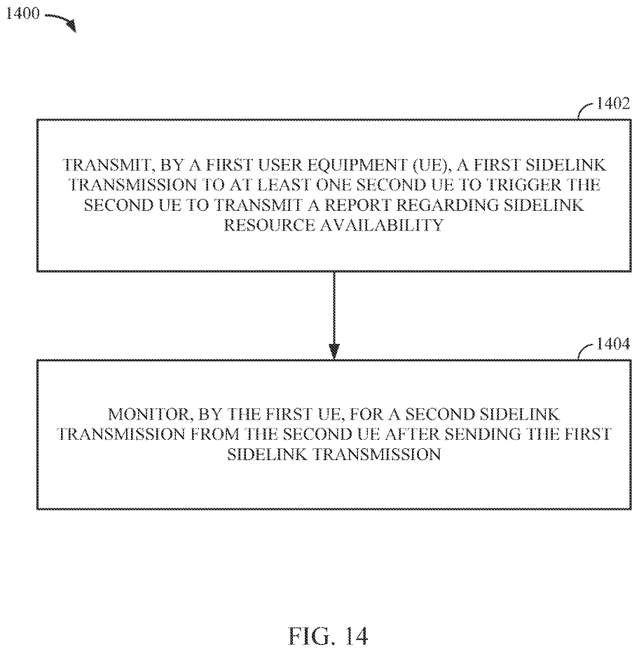

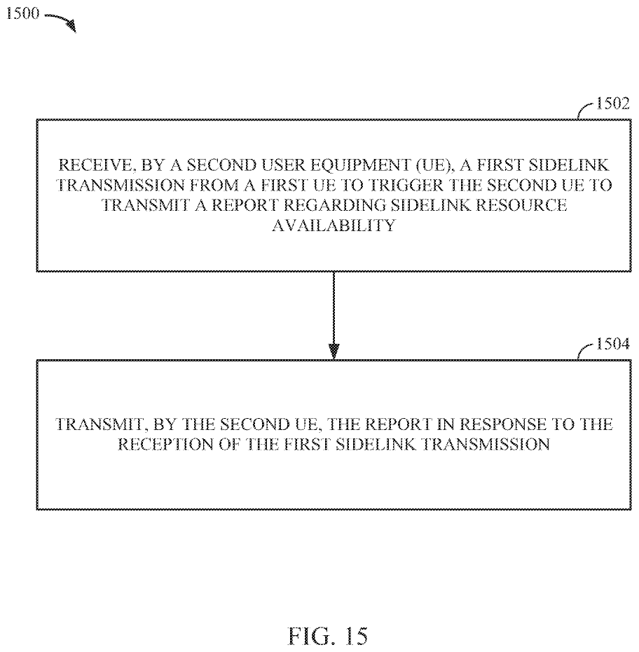

FIG. 1 illustrates an example wireless communication network 100 in which aspects of the present disclosure may be performed. For example, one or more user equipments (UEs) 120 (e.g., UE 120a and UE 120b) of FIG. 1 may be configured to perform operations 1400 of FIG. 14 to request resource reservation information from one or more other UEs and/or to perform operations 1500 of FIG. 15 to process such requests and provide resource reservation information to the requesting UE.

As illustrated in FIG. 1, wireless communication network 100 may include a number of base stations (BSs) 110a-z (each also individually referred to herein as BS 110 or collectively as BSs 110) and other network entities. In aspects of the present disclosure, a roadside service unit (RSU) may be considered a type of BS, and a BS 110 may be referred to as an RSU. A BS 110 may provide communication coverage for a particular geographic area, sometimes referred to as a “cell”, which may be stationary or may move according to the location of a mobile BS 110. In some examples, BSs 110 may be interconnected to one another and/or to one or more other BSs 110 or network nodes (not shown) in wireless communication network 100 through various types of backhaul interfaces (e.g., a direct physical connection, a wireless connection, a virtual network, or the like) using any suitable transport network.

In the example shown in FIG. 1, BSs 110a, 110b and 110c may be macro BSs for the macro cells 102a, 102b and 102c, respectively. BS 110x may be a pico BS for a pico cell 102x. BSs 110y and 110z may be femto BSs for the femto cells 102y and 102z, respectively. A BS 110 may support one or multiple cells. BSs 110 communicate with UEs 120a-y (each also individually referred to herein as UE 120 or collectively as UEs 120) in wireless communication network 100. UEs 120 (e.g., 120x, 120y, etc.) may be dispersed throughout wireless communication network 100, and each UE 120 may be stationary or mobile.

According to certain aspects, UEs 120 may be configured to determine resources to use for sidelink communications (with another UE 120). As shown in FIG. 1, UE 120a includes a sidelink manager 122. Sidelink manager 122 may be configured to transmit/receive a sidelink communication to/from another UE (e.g., such as UE 120b), in accordance with aspects of the present disclosure. As shown in FIG. 1, UE 120b includes a sidelink manager 123. Sidelink manager 123 may be configured to receive/transmit a sidelink communication from/to another UE (e.g., such as UE 120a), in accordance with aspects of the present disclosure.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. Network controller 130 may communicate with BSs 110 via a backhaul. BSs 110 may also communicate with one another (e.g., directly or indirectly) via wireless or wireline backhaul.

UEs 120 (e.g., 120x, 120y, etc.) may be dispersed throughout wireless communication network 100, and each UE may be stationary or mobile. A UE 120 may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs 120 may be considered machine-type communication (MTC) devices or evolved MTC (eMTC) devices. MTC and eMTC UEs include, for example, robots, drones, remote devices, sensors, meters, monitors, location tags, etc., that may communicate with a BS 110, another device (e.g., remote device), or some other entity. A wireless node such as a UE 120 or a BS 110 may provide, for example, connectivity for or to a network (e.g., a wide area network such as Internet or a cellular network) via a wired or wireless communication link Some UEs 120 may be considered Internet-of-Things (IoT) devices, which may be narrowband IoT (NB-IoT) devices.

Certain wireless networks (e.g., LTE) utilize orthogonal frequency division multiplexing (OFDM) on the downlink (DL) and single-carrier frequency division multiplexing (SC-FDM) on the uplink (UL). OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz), and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 RBs), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a cyclic prefix (CP) on the UL and DL and include support for half-duplex operation using time division duplexing (TDD). Beamforming may be supported and beam direction may be dynamically configured. Multiple-input multiple-output (MIMO) transmissions with precoding may also be supported. MIMO configurations in the DL may support up to 8 transmit antennas with multi-layer DL transmissions up to 8 streams and up to 2 streams per UE 120. Multi-layer transmissions with up to 2 streams per UE 120 may be supported. Aggregation of multiple cells may be supported with up to 8 serving cells.

In some examples, access to the air interface may be scheduled. A scheduling entity (e.g., a BS 110) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. BSs 110 are not the only entities that may function as a scheduling entity. In some examples, a UE 120 may function as a scheduling entity and may schedule resources for one or more subordinate entities (e.g., one or more other UEs 120), and the other UEs 120 may utilize the resources scheduled by UE 120 for wireless communication. In some examples, a UE 120 may function as a scheduling entity in a peer-to-peer (P2P) network, and/or in a mesh network. In a mesh network example, UEs 120 may communicate directly with one another in addition to communicating with a scheduling entity.

In FIG. 1, a solid line with double arrows indicates desired transmissions between a UE 120 and a serving BS 110, which is a BS designated to serve the UE on the DL and/or UL. A finely dashed line with double arrows indicates interfering transmissions between a UE 120 and a BS 110.

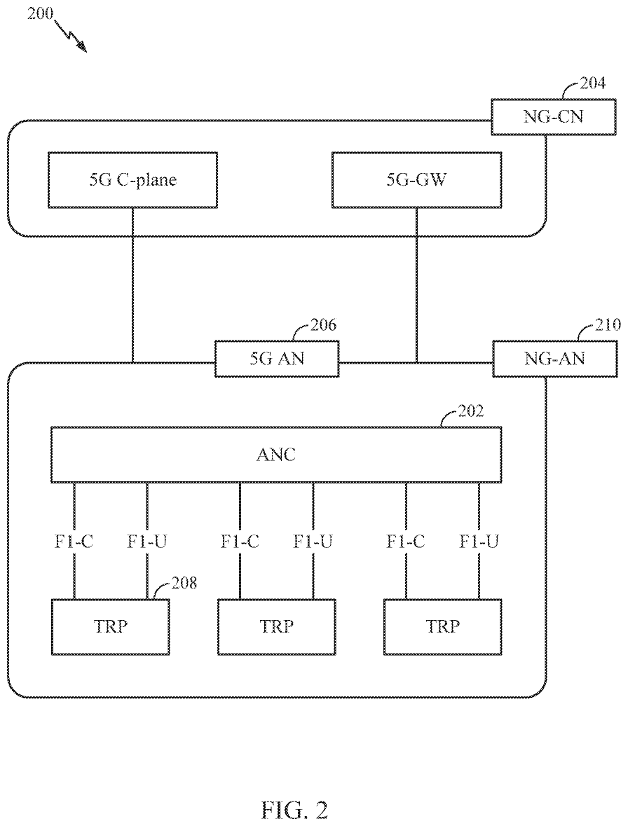

FIG. 2 illustrates an example logical architecture of a distributed Radio Access Network (RAN) 200, which may be implemented in wireless communication network 100 illustrated in FIG. 1. A 5G access node (AN) 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

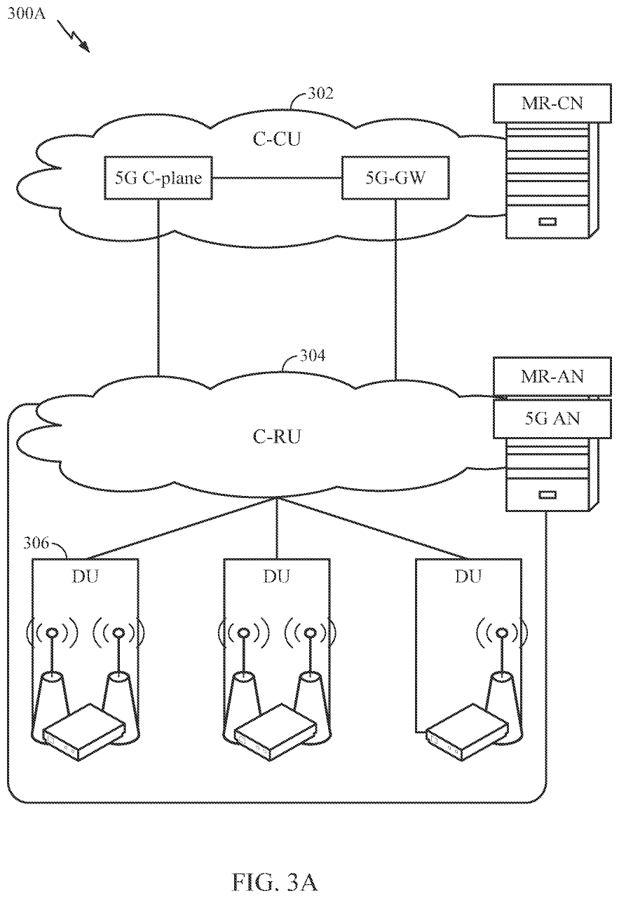

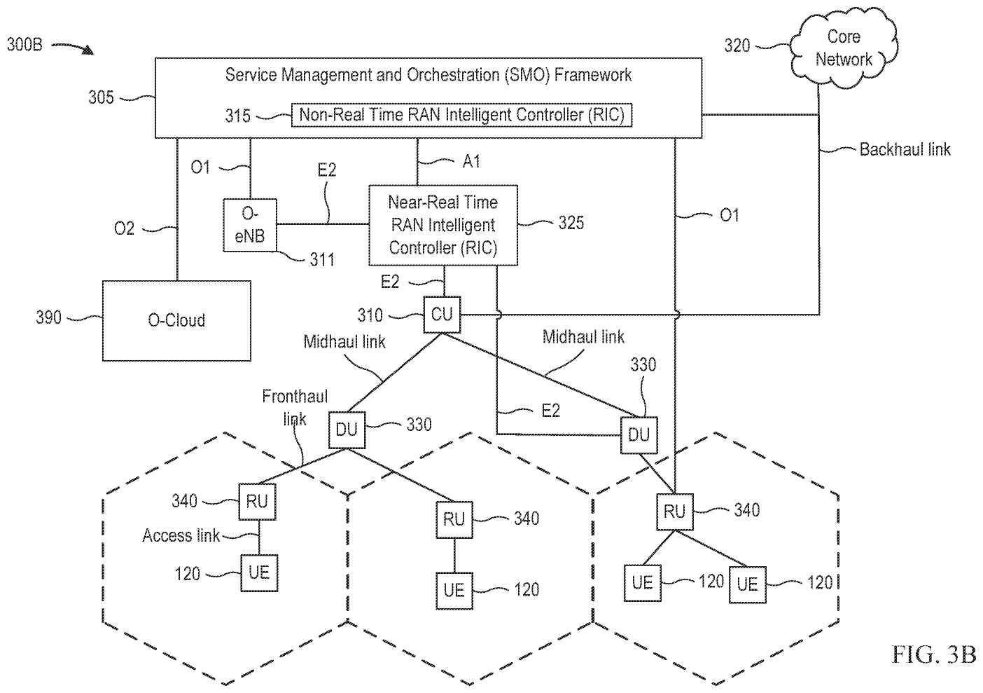

FIG. 3 illustrates an example physical architecture of a distributed RAN 300A, in accordance with certain aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, C-RU 304 may host core network functions locally. C-RU 304 may have distributed deployment. C-RU 304 may be close to the network edge.

A DU 306 may host one or more TRPs (Edge Node (EN), an Edge Unit (EU), a Radio Head (RH), a Smart Radio Head (SRH), or the like). DU 306 may be located at edges of the network with radio frequency (RF) functionality.

BS-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 3B is a diagram illustrating an example disaggregated BS 300B architecture. The disaggregated BS 300B architecture may include one or more central units (CUs) 310 that can communicate directly with a core network 320 via a backhaul link, or indirectly with the core network 320 through one or more disaggregated BS units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3r d Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

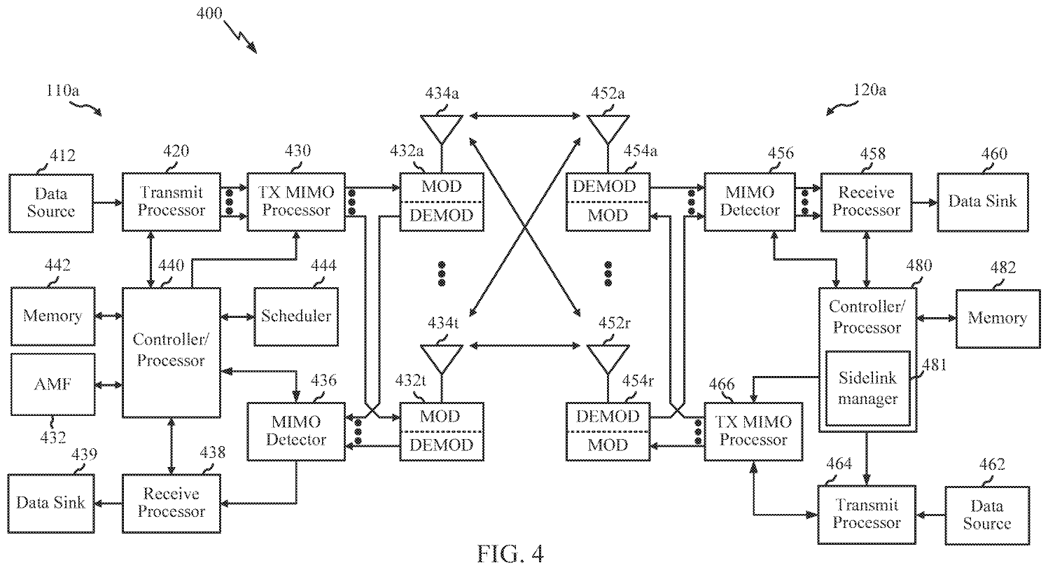

FIG. 4 illustrates example components of BS 110a and UE 120a (as depicted in FIG. 1), which may be used to implement aspects of the present disclosure. For example, antennas 452, processors 466, 458, 464, and/or controller/processor 480 of UE 120a and/or UE 120b may be used to perform the various techniques and methods described herein with reference to FIGS. 14 and/or 15.

At BS 110a, a transmit processor 420 may receive data from a data source 412 and control information from a controller/processor 440. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be for the physical downlink shared channel (PDSCH), etc. Processor 420 may process (e.g., encode and symbol map) the data and control information to obtain data symbols and control symbols, respectively. Processor 420 may also generate reference symbols, e.g., for the primary synchronization signal (PSS), secondary synchronization signal (SSS), and cell-specific reference signal (CRS). A transmit (TX) MIMO processor 430 may perform spatial processing (e.g., precoding) on the data symbols, the control symbols, and/or the reference symbols, if applicable, and may provide output symbol streams to the modulators (MODs) in transceivers 432a through 432t. Each modulator in transceiver 432 may process a respective output symbol stream (e.g., for OFDM, etc.) to obtain an output sample stream. Each modulator may further process (e.g., convert to analog, amplify, filter, and upconvert) the output sample stream to obtain a DL signal. DL signals from modulators in transceivers 432a through 432t may be transmitted via the antennas 434a through 434t, respectively.

At UE 120a, antennas 452a through 452r may receive the DL signals from BS 110a and may provide received signals to the demodulators (DEMODs) in transceivers 454a through 454r, respectively. Each demodulator may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators in transceivers 454a through 454r, perform MIMO detection on the received symbols if applicable, and provide detected symbols. A receive processor 458 may process (e.g., demodulate, deinterleave, and decode) the detected symbols, provide decoded data for UE 120a to a data sink 460, and provide decoded control information to a controller/processor 480.

On the UL, at UE 120a, a transmit processor 464 may receive and process data (e.g., for the physical uplink shared channel (PUSCH)) from a data source 462 and control information (e.g., for the physical uplink control channel (PUCCH) from the controller/processor 480. Transmit processor 464 may also generate reference symbols for a reference signal (RS) (e.g., for the sounding reference signal (SRS)). The symbols from transmit processor 464 may be precoded by a TX MIMO processor 466 if applicable, further processed by the demodulators in transceivers 454a through 454r (e.g., for SC-FDM, etc.), and transmitted to BS 110a. At BS 110a, the UL signals from UE 120a may be received by antennas 434, processed by modulators in transceivers 432, detected by a MIMO detector 436 if applicable, and further processed by a receive processor 438 to obtain decoded data and control information sent by the UE 120a. Receive processor 438 may provide the decoded data to a data sink 439 and the decoded control information to controller/processor 440.

Controllers/processors 440 and 480 may direct the operation at BS 110a and UE 120a, respectively. Processor 440 and/or other processors and modules at BS 110a may perform or direct the execution of processes for the techniques described herein. As shown in FIG. 4, controller/processor 480 of UE 120a has a sidelink manager 481 (e.g., similar to sidelink manager 122 for UE 120a and sidelink manager 123 for UE 120b in FIG. 1) that may be configured to perform operations 1400 of FIG. 14 and/or operations 1200 of FIG. 15. Although shown at controller/processor 480, other components of UE 120a may be used for performing the operations described herein.

Memories 442 and 482 may store data and program codes for BS 110a and UE 120a, respectively. A scheduler 444 may schedule UEs 120 for data transmission on the DL, sidelink, and/or UL.

### Example Sidelink Communications

While communication between UEs (e.g., UE 120a or UE 120b of FIG. 1) and BSs (e.g., BS 110a of FIG. 1) may be referred to as the access link, and the access link may be provided via a cellular interface (e.g., Uu interface), communication between devices may be referred to as the sidelink.

In some examples, two or more subordinate entities (e.g., UEs 120) may communicate with each other using sidelink signals. Real-world applications of such sidelink communications may include public safety, proximity services, UE-to-network relaying, vehicle-to-vehicle (V2V) communications, Internet of Everything (IoE) communications, Internet of Things (IoT) communications, mission-critical mesh, and/or various other suitable applications. Generally, a sidelink signal may refer to a signal communicated from one subordinate entity (e.g., UE 120a illustrated in FIG. 1) to another subordinate entity (e.g., UE 120b illustrated in FIG. 1) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

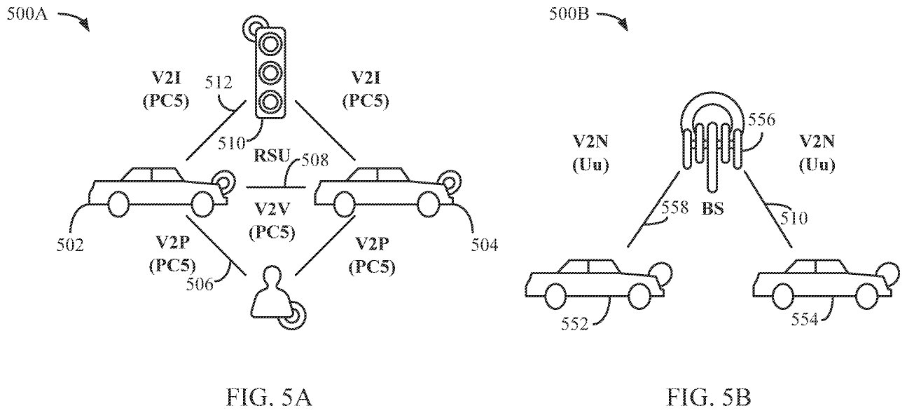

FIGS. 5A and 5B show diagrammatic representations of example vehicle to everything (V2X) systems 500A and 500B, respectively, in accordance with certain aspects of the present disclosure. For example, the vehicles shown in FIGS. 5A and 5B may communicate via sidelink channels and may relay sidelink transmissions as described herein.

V2X systems 500a and 500B, provided in FIGS. 5A and 5B, respectively, provide two complementary transmission modes. A first transmission mode, shown by way of example in FIG. 5A, involves direct communications (for example, also referred to as sidelink communications) between participants in proximity to one another in a local area. A second transmission mode, shown by way of example in FIG. 5B, involves network communications through a network, which may be implemented over a Uu interface (for example, a wireless communication interface between a radio access network (RAN) and a UE).

Referring to FIG. 5A, a V2X system 500A (for example, including V2V communications) is illustrated with two vehicles 502, 504 (e.g., UEs). The first transmission mode allows for direct communication between different participants in a given geographic location. As illustrated, a vehicle may have a wireless communication link 506 with an individual (i.e., vehicle to person (V2P), for example, via a UE) through a PC5 interface. Communications between vehicles 502 and 504 may also occur through a PC5 interface 508. In a like manner, communication may occur from a vehicle 502 to other highway components (for example, roadside service unit (RSU) 510), such as a traffic signal or sign (i.e., vehicle to infrastructure (V2I)) through a PC5 interface 512. With respect to each communication link illustrated in FIG. 5A, two-way communication may take place between elements, therefore each element may be a transmitter (TX) and a receiver (RX) of information. V2X system 500A may be a self-managed system implemented without assistance from a network entity. A self-managed system may enable improved spectral efficiency, reduced cost, and increased reliability as network service interruptions do not occur during handover operations for moving vehicles. V2X system 500A may be configured to operate in a licensed or unlicensed spectrum, thus any vehicle with an equipped system may access a common frequency and share information. Such harmonized/common spectrum operations allow for safe and reliable operation.

FIG. 5B shows a V2X system 500B for communication between a vehicle 552 (e.g., UE) and a vehicle 554 (e.g., UE) through a network entity 556. These network communications may occur through discrete nodes, such as a BS (for example, an eNB or gNB), that sends and receives information to and from (for example, relays information between) vehicles 552, 554. The network communications through vehicle to network (V2N) links 558 and 510 may be used, for example, for long-range communications between vehicles, such as for communicating the presence of a car accident a distance ahead along a road or highway. Other types of communications may be sent by the node to vehicles, such as traffic flow conditions, road hazard warnings, environmental/weather reports, and service station availability, among other examples. Such data can be obtained from cloud-based sharing services.

As described above, V2V and V2X communications are examples of communications that may be transmitted via a sidelink. When a UE is transmitting a sidelink communication on a sub-channel of a frequency band, the UE is typically unable to receive another communication (e.g., another sidelink communication from another UE) in the frequency band.).

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions.

For the operation regarding PSSCH, a UE performs either transmission or reception in a slot on a carrier. A reservation or allocation of transmission resources for a sidelink transmission is typically made on a sub-channel of a frequency band for a period of a slot. New Radio (NR) sidelink supports, for a UE, a case where all the symbols in a slot are available for sidelink, as well as another case, where only a subset of consecutive symbols in a slot is available for sidelink.

PSFCH may carry feedback such as channel state information (CSI) related to a sidelink channel quality. A sequence-based PSFCH format with one symbol (not including automatic gain control (AGC) training period) may be supported. The following formats may be possible: a PSFCH format based on PUCCH format 2 and a PSFCH format spanning all available symbols for sidelink in a slot.

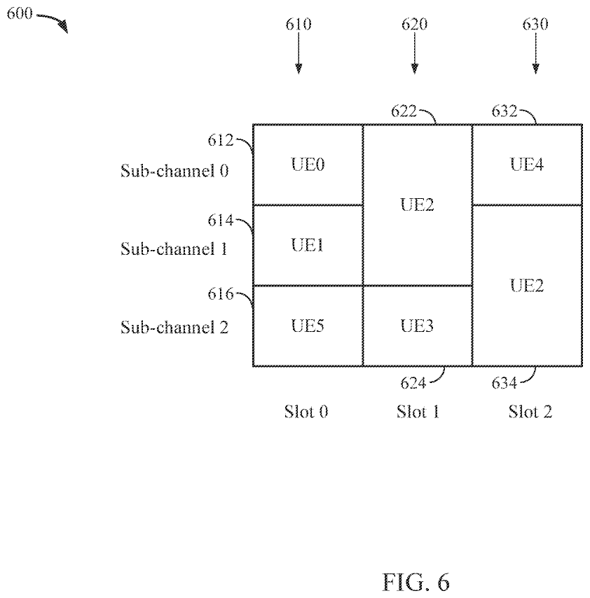

FIG. 6 is an example of how resources of a common resource pool 600 may be allocated for sidelink communications (broadcast and groupcast D2D) between UEs (e.g., UEs 120, shown in FIG. 1). As noted above, with reference to FIGS. 5A and 5B, sidelink generally refers to the link between two users, or user-relays can be used in different scenarios and for different applications. As previously described, when a UE is transmitting a sidelink communication on a sub-channel of a frequency band, the UE is typically unable to receive another communication (e.g., another sidelink communication from another UE) in the frequency band. Thus, sidelink communications may be referred to as being half-duplex. Thus, UEs 0, 1, and 5, which transmit sidelink communications 612, 614, and 616 respectively, cannot receive the sidelink communications from each other. That is, UE 0 cannot receive sidelink transmissions 614 and 616. Similarly, UE 2 cannot receive sidelink transmission 624 and 632 from UEs 3 and 4, respectively. Also, UE 3 cannot receive sidelink transmission 622 from UE 2, and UE 4 cannot receive the sidelink transmission 634 from UE 2.

In aspects of the present disclosure, sidelink transmission(s) that cannot be received may be referred to as being “erased” for the UE, or wireless node, that cannot receive the sidelink transmission, because the UE has no information regarding that sidelink transmission. This is unlike other situations in which a UE fails to decode a transmission, because in those situations, the UE may retain some information regarding the transmission that the UE failed to decode, and the UE may combine that retained information with a retransmission that the UE receives to determine the transmission that the UE failed to decode.

According to previously known techniques, resource allocation is reservation based in NR sidelink communications. In these techniques, resource allocations are made in units of sub-channels in the frequency domain and are limited to one slot in the time domain (e.g., slot 610). Further, a transmission may reserve resources in the current slot and in up to two future slots (e.g., slots 620 and 630). Reservation information may be carried in sidelink control information (SCI). In the previously known techniques, sidelink control information (SCI) may be transmitted in two stages. A first stage SCI (SCI-1) may be transmitted on a physical sidelink control channel (PSCCH) and contains resource reservation information as well as information needed to decode a second stage SCI (SCI-2). An SCI-2 may be transmitted on the PSSCH and contains information needed to decode data on the shared channel (SCH) and to provide feedback (e.g., acknowledgments (ACKs) or negative acknowledgments (NAKs)) over the PSFCH.

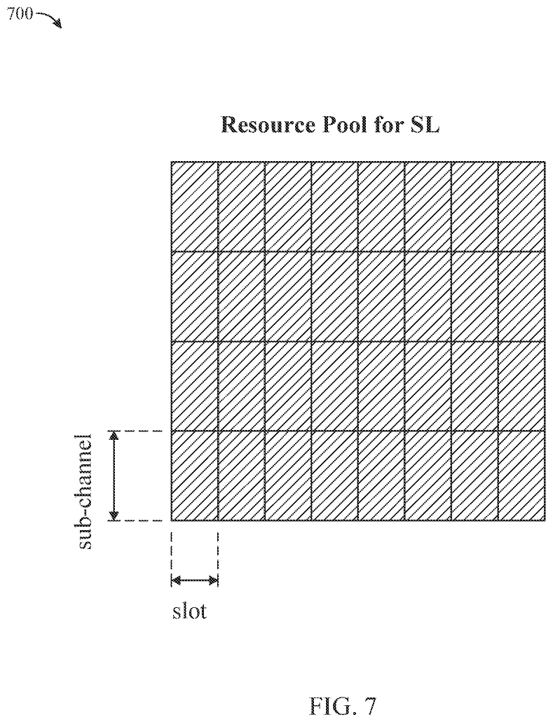

FIG. 7 is an example resource pool 700 for sidelink communication, in accordance with certain aspects of the present disclosure. As illustrated, the minimum resource allocation unit is a sub-channel in the frequency domain (i.e., as shown in the y axis), and the resource allocation in the time domain is a slot (i.e., as shown in the x axis). For example, depending on subcarrier spacing (SCS) values, and depending on whether a normal cyclic prefix (CP) or an extended CP is used, a slot in the time domain may include 12 or 14 orthogonal frequency division multiplexing (OFDM) symbols.

In the frequency domain, each sub-channel may include a set number of consecutive resource blocks (RBs), which may include 12 consecutive subcarriers with the same SCS, such as 10, 15, 20, 25 . . . etc. consecutive RBs depending on practical configuration. Hereinafter, each unit of resource in one slot and in one sub-channel is referred to as a resource, or resource unit. For a certain resource pool, the resources therein may be referred to using the coordinates of the slot index (e.g., the n^{th} slot in the x axis of the time domain) and the sub-channel index (e.g., the m^{th} sub-channel in the y axis of the frequency domain). Interchangeably, the slot index may be referred to as the time index; and the sub-channel index may be referred to as the frequency index.

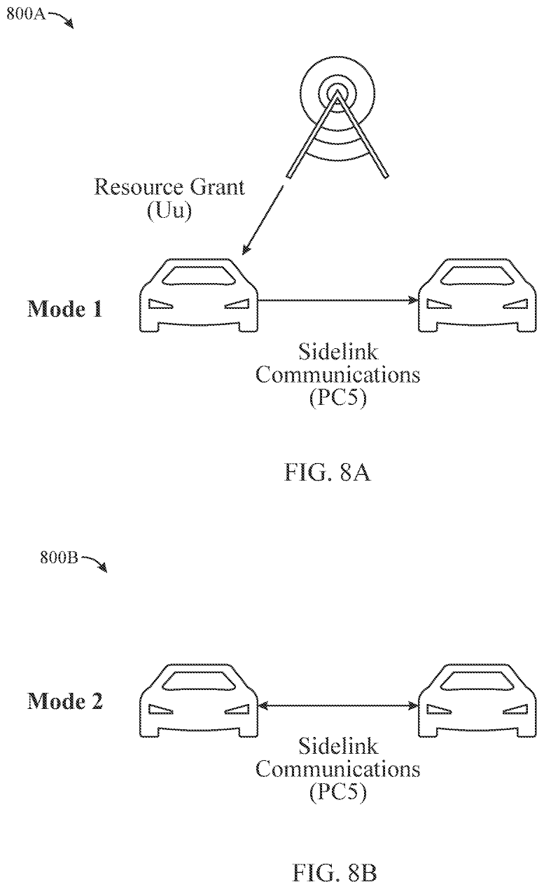

In NR, there are generally two basic sidelink resource allocation modes. FIGS. 8A and 8B illustrate two modes of resource allocation for sidelink communications 800A and 800B, respectively, in accordance with certain aspects of the present disclosure. RX UE behavior may be the same for both sidelink resource allocation modes.

According to a first mode (Mode 1), as shown in FIG. 8A, a BS allocates resources for sidelink communications between UEs. For example, a BS may transmit downlink control information (DCI) (e.g., DCI_3_0) to allocate time and frequency resources and indicate transmission timing. A modulation and coding scheme (MCS) may be determined by a UE within the limit set by the BS.

According to a second mode (Mode 2), as shown in FIG. 5B, UEs determine the sidelink resources (the BS does not schedule sidelink transmission resources within sidelink resources configured by BS/network). In this case, UEs autonomously select sidelink resources (i.e., UEs perform resource allocation on their own) (following some rules in the NR standard). A UE may assist in sidelink resource selection for other UEs. A UE may be configured with an NR configured grant for sidelink transmission, and the UE may schedule sidelink transmissions for other UEs. When the UE is in-coverage, a BS may be configured to adopt Mode 1 or Mode 2. When the UE is out of coverage, only Mode 2 may be adopted.

In Mode 2, when traffic arrives at a transmitting UE, the transmitting UE may select resources for PSCCH and PSSCH, and/or reserve resources for retransmissions to minimize latency. Therefore, in conventional configurations, the transmitting UE may select resources for PSSCH associated with PSCCH for initial transmission and blind retransmissions, which incurs unnecessary resources and related power consumption. To avoid such resource waste and other similar resource duplication/blind reservation/redundancy, the UEs in sidelink communication may communicate to use a subset of the resources.

### Example Reliability Enhancement for Sidelink Communication

As noted above, sidelink resource allocation may be either base station (BS)-assisted (e.g., gNB-assisted) (Mode 1) or autonomous (Mode 2). Aspects of the present disclosure may be utilized with Mode 2 resource allocation, where user equipments (UEs) reserve resources (from a set of candidate resources) on their own (e.g., without the assistance of a BS).

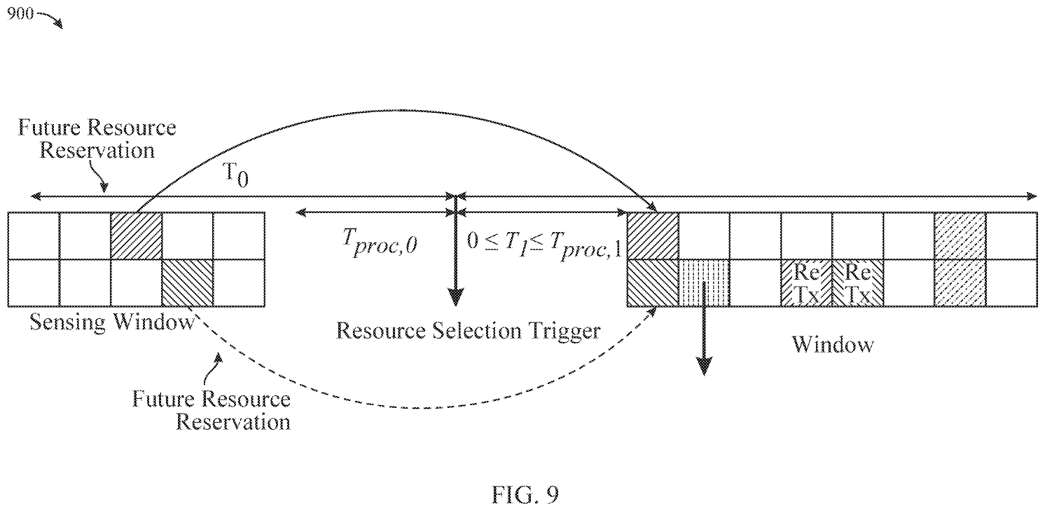

FIG. 9 is a diagram 900 illustrating an example sensing window and a resource selection window, in accordance with certain aspects of the present disclosure. As illustrated in FIG. 9, according to Mode2 resource allocation, any transmitter UE (TX-UE) may sense, within a sliding sensing window, to detect resources, for example, indicated by future resource reservations. Information regarding future reservations may be obtained by decoding sidelink control information (SCIs) in the sensing window. These future reservations may be checked for availability based on received signal levels in the sensing window. Within a subset of available resources, within the resource selection window, one or more reservations may be made randomly. The time location of the resource selection window may be determined, for example, based on a remaining packet delay budget (PDB).

In the example illustrated in FIG. 9, two future reservations are sensed in the sensing window, reserving resources in a resource selection window. As illustrated, resources may also be reserved for re-transmissions. Within the remaining subset of available resources (e.g., excluding the two future reservations), within the resource selection window, the TX UE may reserve one or more resources (e.g., randomly) for its own transmission.

There may be certain limitations for some UEs with regard to sensing-based resource selection. For example, some TX-UEs may be power-sensitive and may not be able to afford (from a power budget perspective) sensing continuously on all resources. In some cases, a receiver UE (an RX-UE), that is more capable in terms of power, may perform the sensing and report back resource availability information to the TX-UE. The RX-UE may be, for example, the RX-side targeted recipient of unicast (e.g., one-to-one)/groupcast (e.g., one-to-group) communications (e.g., from the TX-UE).

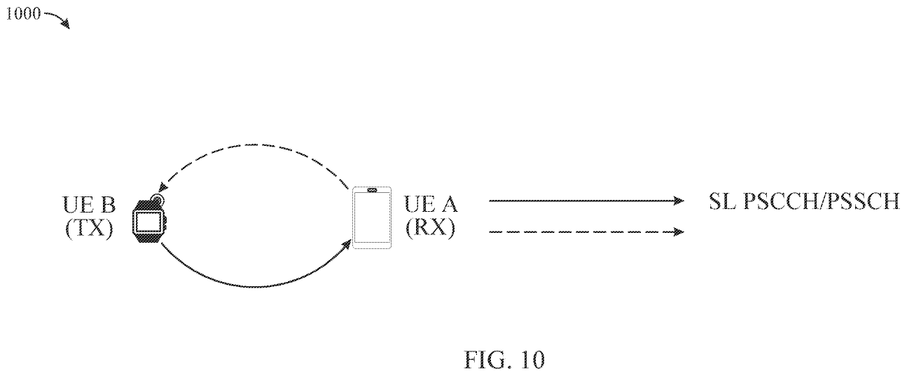

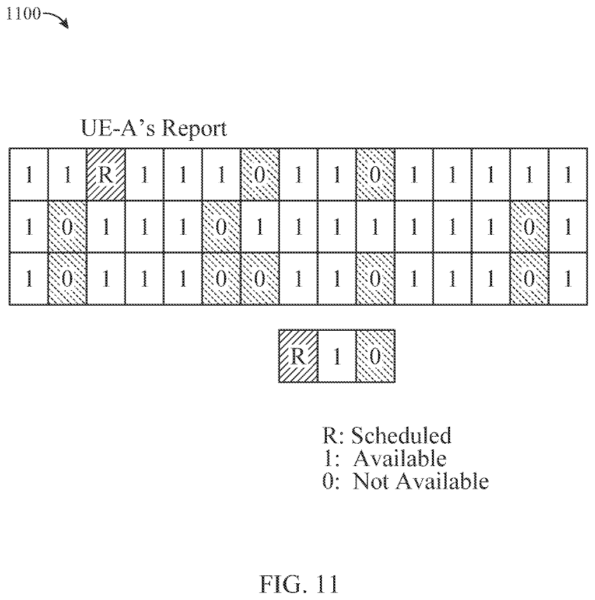

The availability checks performed on the RX-UE side may be performed as described above. For example, FIG. 10 is a diagram illustrating example coordination between UEs (e.g., inter-UE coordination), in accordance with certain aspects of the present disclosure. An RX-UE, UE-A in FIG. 10, may check for each reserved resource for availability by using observed received signal received power (RSRP) levels observed. As illustrated in FIG. 10, UE-A may then report back to the TX-UE, UE-B, a binary report of resource availability (candidate resource set). These reports can be either aperiodic based on a trigger or periodic on reserved reporting resources (see last slide).

In certain aspects, the candidate resource set reported by UE-A to UE-B may include all available resources. Alternatively, in certain aspects, UE-A may report back to UE-B only a subset of the actual available resources (e.g., less than all available resources). In some cases, the subset of available resources may be resources UE-A prefers UE-B use in transmission (referred to as a “preferred resource set”). Accordingly, in this case, UE-A may not report back to UE-B resources which UE-A does not prefer (referred to as a “non-preferred resource set”).

In certain aspects, the candidate resource set reported by UE-A to UE-B is limited. In particular, a number of candidate resources to be reported by UE-A may be less than a (pre-)configured threshold (e.g., a (pre-)configured number of resources). By limiting the number of resources which UE-A may report back to UE-B may (1) allow for less processing by UE-B after receiving the report from UE-A and/or (2) less signaling overhead to transmit the report to UE-B.

FIG. 11 illustrates an example binary report 1100 from UE-A, in accordance with certain aspects of the present disclosure. As shown in FIG. 11, example binary report 1100 may indicate available resources (‘1’) and/or unavailable resources (‘0’). UE-A may further indicate (mark) a subset of resources of size M which are scheduled on behalf of UE-B (e.g., a priori). In the illustrated example, the number of resources (M) scheduled for reporting to UE-B is one (M=1) (e.g., marked as “R” or “Scheduled” on behalf of UE-B in FIG. 11).

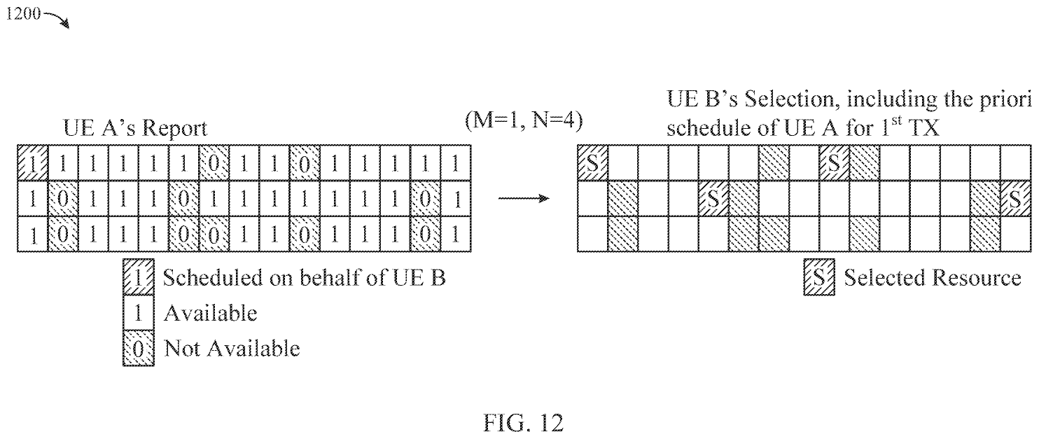

FIG. 12 illustrates an example of UE-B's resource selection 1200, including a priori scheduling of UE-A for an initial transmission (e.g., first transmission of a transport block (TB)). As with the example shown in FIG. 11, UE-A transmits a report which contains resource availability information in which for each resource, UE-A may report 1 bit and also indicate a subset of resources of size M which are scheduled on behalf of UE-B, a priori.

As illustrated in FIG. 12, UE-B may decode this report and randomly select (N-M) resources from the set of available resources for its potential N transmissions of a newly generated packet (0<=M<=N). Resources selected for UE B's transmission, including the priori scheduling of UE-A for the first transmission are labeled as “S” or “Scheduled resource”.

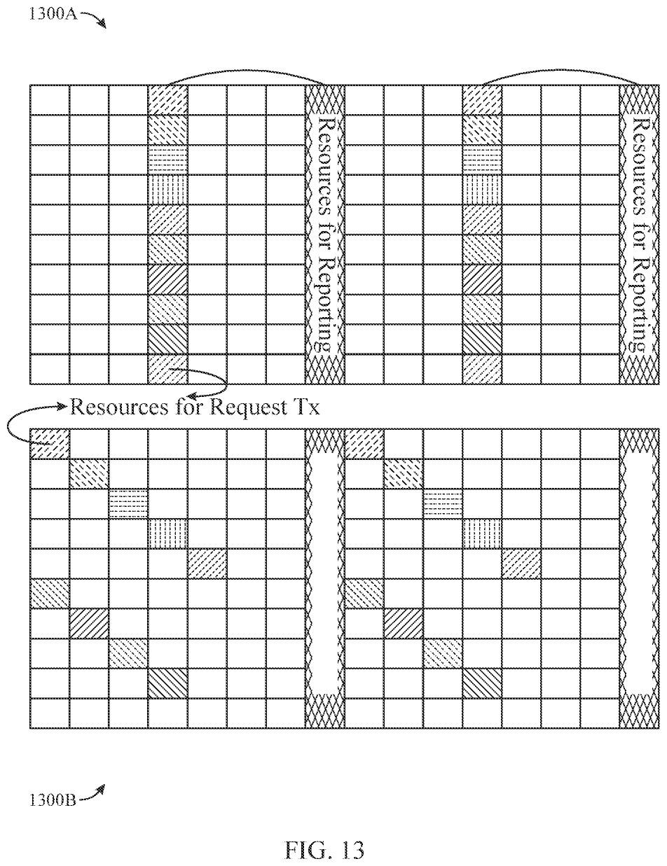

FIG. 13 illustrates an example resource configuration for inter-UE coordination requests and reporting, in accordance with certain aspects of the present disclosure. As illustrated in FIG. 13, the resources for request and/or report signaling may be configured with a certain periodicity. The request and/or reporting resources may be present in one sidelink slot (as illustrated in the top diagram 1300A) or may be distributed over multiple sidelink slots (as illustrated in the bottom diagram 1300B). Each requested resource may be a single sub-channel or multiple subchannels.

One potential issue, in particular when the traffic pattern of UE-B is aperiodic or periodic with large periodicity, is that frequent periodic reporting by UE-A may lead to congestion on the shared reporting channel. This, in turn, may result in report collisions and decreased reliability for transmissions from UE-B.

### Example Techniques for Requesting Inter-UE Coordination Messages for NR Sidelink

Aspects of the present disclosure relate to wireless communications, and more particularly, to enhancements for device-to-device (D2D) sidelink communications based on efficient inter-UE coordination that involves requests for resource reservation information.

In some cases, a first user equipment (UE) may transmit a sidelink message to trigger (e.g., request) a second UE to transmit a report regarding sidelink resource availability from the second UE's perspective. When compared to frequent periodic reporting, the request-based reporting techniques described herein may be adapted to traffic patterns, which may help conserve resources, avoid congestion on a shared reporting channel, and improve reliability for sidelink transmissions.

In some cases, a new packet generated by a TX-UE (e.g., UE-B in FIG. 10) may be used to generate a trigger for initiating reporting at an RX-UE (e.g., UE-A in FIG. 10). In other words, rather than maintaining reserved requesting resources for UE-B, it may be possible to create a trigger by an initial transmission. This initial transmission may or may not be based on previous/future sensing results at UE-B.

FIG. 14 illustrates example operations 1400 for wireless communications by a first UE (e.g., a TX UE such as UE-B), in accordance with certain aspects of the present disclosure. For example, operations 1400 may be performed by UE 120a of FIG. 1 or FIG. 4 when performing sidelink communications with another UE (e.g., UE 120b of FIG. 1 or FIG. 4).

Operations 1400 begin, at 1402, by the first UE transmitting a first sidelink transmission to at least a second UE to trigger the second UE to transmit a report regarding sidelink resource availability. In certain aspects, the sidelink transmission to at least the second UE to trigger (e.g., request) the second UE to transmit the report may be contained in a medium access control (MAC) control element (CE) (MAC-CE). In certain aspects, the sidelink transmission to at least the second UE to trigger (e.g., request) the second UE to transmit the report may be contained in SCI, for example, SCI2. Given a MAC-CE requires some upper layer intervention, as well as processing of a received packet by the upper layers, there may be greater delay in using a MAC-CE as opposed to SCI2 for transmitting the request to UE-A. In particular, SCI2 may require only processing in the physical (PHY) layer, as opposed to upper layers of the protocol stack.

Further, in certain aspects, the sidelink transmission to at least the second UE including the request may be multiplexed with other data, such that other data and request data may be in a same transmission. In this case, the source/destination identifier (ID) for the request and the data may be the same. A MAC-CE may be used to multiplex the other data with the request data.

At 1404, the first UE monitors for a second sidelink transmission from the second UE after transmitting the first sidelink transmission.

FIG. 15 illustrates example operations 1500 for wireless communications by a second UE (e.g., an RX UE such as UE-A), in accordance with certain aspects of the present disclosure. Operations 1500 may be considered complementary to operations 1400 of FIG. 14. For example, operations 1500 may be performed by UE 120b of FIG. 1 to process future resource reservation information request received from another UE (e.g., a TX UE, UE-B performing operations 1400 of FIG. 14).

Operations 1500 begin, at 1502, by the second UE receiving a first sidelink transmission from a first UE to trigger the second UE to transmit a report regarding sidelink resource availability. At 1504, the second UE transmits the report in response to the reception of the first sidelink transmission.

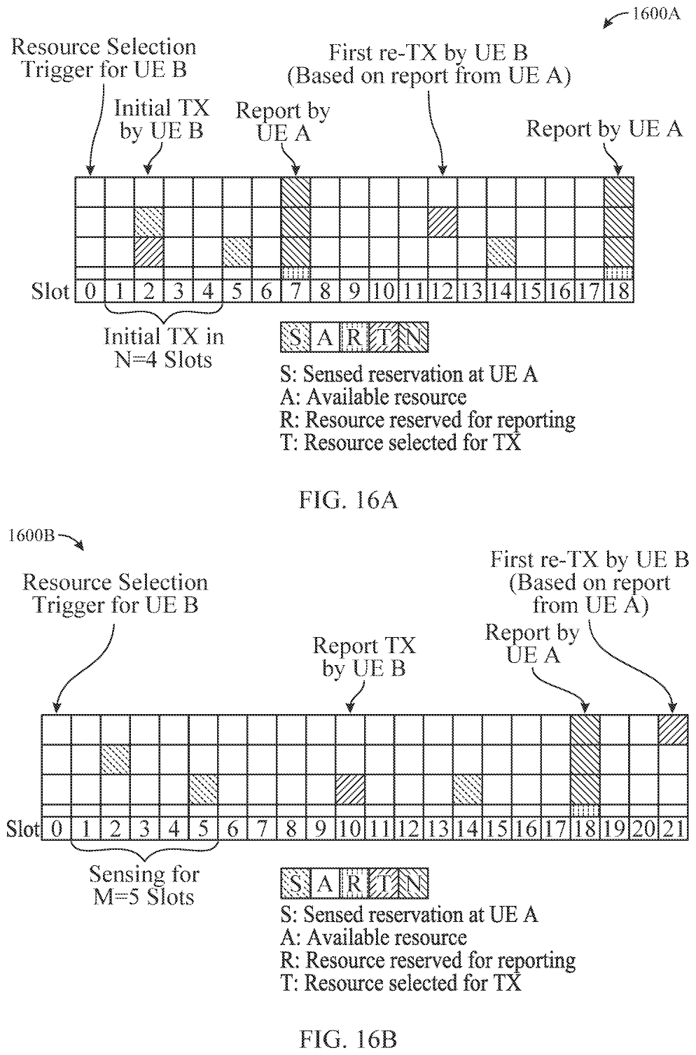

Operations 1400 and 1500 may be understood with reference to FIGS. 16A-16B, which illustrate examples 1600A and 1600B, respectively, of triggering aperiodic reporting using regular (sidelink) transmissions, in accordance with certain aspects of the present disclosure.

As illustrated in FIGS. 16A and (e.g., a TX UE such as UE-B), UE-B may trigger reporting at UE-A by transmitting an initial transmission. As noted above, this initial transmission may or may not be based on previous/future sensing results at UE-B.

For example, as illustrated in FIG. 16A, according to a first option (Option 1), UE-B may immediately (e.g., without any intervening time, or in a subsequent slot) make a random selection on one of N slots (e.g., slots 1-4 following a resource selection trigger for UE-B in slot 0) without performing sensing. In the illustrated example, UE-B randomly selects slot 2 for the initial transmission. In some cases (Option 1-1), UE-B may use a same number of sub-channels used for regular packet/transport block (TB) transmission and transmit regular data. In other cases (Option 1-2), UE-B may use a minimum number of sub-channels (e.g., 1 sub-channel), for example, transmitting a dummy transmission of all-zeros/no information bits.

As illustrated in FIG. 16A, the report by UE-A may subsequently follow (e.g., in slot 7). In some cases, depending on the feedback/report by UE-A, UE-B may transmit a first re-transmission (e.g., in slot 12), triggering additional reporting by UE-A (e.g., at slot 18). As illustrated, due to report reception, UE-B may not reserve any resources for transmission in a slot used for reporting. Following the re-transmission, UE-A may transmit a report to UE-B (e.g., in slot 18).

In other cases, as illustrated in FIG. 16B, according to a second option (Option 2), UE-B may sense the channel, either partially or fully, for M slots (e.g., slots 1-5 assuming M=5) and perform the initial transmission (e.g., in slot 10) based on this sensing. As in the example described above, UE-B may transmit a regular TB transmission (e.g., using a same number of sub-channels as for a regular packet, referred to herein as Option 2-1) or a dummy TB transmission (e.g., using 1 sub-channel and with no data, referred to herein as Option 2-2).

In the case where UE-B transmits a regular TB to trigger reporting (e.g., Options 1-1 and 2-1), after receiving the initial transmission, UE-A may transmit an acknowledgement (ACK) on the feedback channel (e.g., PSFCH), such as a hybrid automatic repeat request (HARQ) ACK, indicating UE-A has successfully decoded the initial transmission. In this case, UE-A may not initiate a reporting phase. In some other cases, UE-A may transmit a negative ACK (NACK) and initiate a reporting phase, for example, where UE-A can successfully decode sidelink control information (e.g., SCI1 and SCI2) but not the physical sidelink shared channel (PSSCH).

In the case where UE-A fails to decode either SCI1 or SCI2, UE-A may have not have any knowledge/information on the triggering transmission of UE-B. Accordingly, UE-A may not be able to respond to UE-B's request over the PSFCH or the reporting channel.

For Option 1-1 and 2-1, based on the response (if any) from UE-A, UE-B may take various actions. The particular action taken may depend on a type of traffic, aperiodic or periodic, that UE-B has to transmit.

For example, for aperiodic traffic, UE-B may stop a transmission of a current TB and may return to a power saving mode when UE-B receives an ACK for its initial transmission (indicating successful reception by UE-A). If UE-B has some priori knowledge of a next packet arrival, or if the next packet has already arrived, UE-B may wait for the report from UE-A.

For periodic traffic, based on the next packet arrival time or frequency of packet arrivals, UE-B may wait for the report when it receives an ACK.

In some cases, for both periodic and aperiodic traffic, UE-B may wait for the report from UE-A when UE-B receives a NACK on the PSFCH. Based on information in the report, UE-B may perform retransmissions, for example, on either: the resources scheduled by UE-A or on the resources UE-B randomly selects from the candidate resource set provided by UE-A's report.

For both periodic and aperiodic traffic, UE-B may re-transmit the TB by another randomly selected resource when UE-B does not receive any ACK/NACK from UE-A. UE-B may alternatively wait for the report from UE-A, for example, if it is known that the report is to arrive before a (pre-)configured deadline. In this case, UE-B may re-transmit via a randomly selected resource, following the deadline, if UE-B does not receive the report.

In case UE-B triggers reporting with a dummy transmission (e.g., Options 1-2 and 2-2), after receiving the initial transmission from UE-B, UE-A may transmit an ACK/NACK on the feedback channel (e.g., PSFCH) and initiate a reporting phase if UE-A is able to successfully decode SCI1 and SCI2. If UE-A has no information on the triggering transmission of UE-B (e.g., where UE-A fails to decode either SCI1 or SCI2), UE-A may not be able to respond to UE-B's request over the PSFCH or the reporting channel.

For options 1-2 and 2-2, based on the response from UE-A (if any), UE-B may wait for the report from UE-A if UE-B receives an ACK/NACK on the PSFCH. Based on the report, UE-B may perform an initial TB transmission and retransmission(s) on either the resources scheduled by UE-A or the resources UE-B randomly selects from the candidate resource set provided by UE-A's report. In some cases, UE-B may re-transmit the dummy TB by another randomly selected resource if UE-B does not receive any ACK/NACK from UE-A. UE-B may alternatively wait for the report from UE-A, for example, if the report is known to arrive before a (pre-)configured deadline, and UE-B may re-transmit via a randomly selected resource following the deadline (when the report is not received).

If sensing is performed, for Options 2-1 and 2-2, after sensing the last slot that is required for the initial TX resource selection, UE-B may take various actions. In some cases, UE-B may stop sensing immediately in order to save power. In other cases, UE-B may continue with its partial or full sensing procedure in order to combine its own sensing information with information that may be potentially received from (e.g., reported by) UE-A.

For example, UE-B may use the sensing results for one or more transmissions of UE-B following the initial transmission or for re-evaluation. For example, UE-B may perform retransmission or re-evaluate the resources selected/used for the first transmission. In this way, UE-B may have the potential to re-allocate resources, if not reserved, if UE-B makes a different decision (based on the re-evaluation) for its own transmission.

Which schemes are used may depend on certain conditions and/or objectives. For example, schemes where UE-B performs channel sensing before the initial transmission (e.g., Options 2-1 and 2-2), may be expected to have higher reliability for the initial transmission (e.g., particularly for heavily loaded networks). On the other hand, schemes where UE-B randomly selects resources (e.g., Options 1-1 and 1-2), may be better suited for low latency (without the sensing phase) and low power consumption scenarios.

Schemes using a dummy transmission (e.g., Options 1-2 and 2-2) may be better suited when the sidelink channel is heavily loaded, since these options may consume fewer resources (when compared to Options 1-1 and 2-1) for the initial transmission.

In some cases, UE-B may continue requesting a report until UE-B receives a report (and/or ACK) from UE-A, or until the packet delay budget (PDB) for a packet is consumed.

In some cases, which option UE-B selects to use, may be based on various considerations. For example, the selection between different options may be based on the priority of the packet to be transmitted by UE-B, the remaining PDB of the corresponding packet (e.g., as noted above, Options 1-1 and 1-2 may have better latency properties), and/or a number of sub-channels to be used for transmission of the packet. In some cases, the selection may be based on sidelink channel state information (CSI) report value(s) or RSRP/reference signal received quality (RSRQ) measurements on the link from reporting UE-A, the pathloss and/or distance estimation and/or zone identifier (ID) for UE-A, or a reliability requirement for the corresponding packet. In some cases, UE-B may make the selection while also considering the power control levels used by UE-B, the communication range requirements on the link from UE-B to UE-A, or the cast type (unicast/groupcast) of communications for the packet. In some cases, the selection may be based on a resource reservation interval, a start time of a resource selection window, or an end time of the resource selection window.

In some cases, UE-B may blindly re-transmit, for example, regardless of whether UE-B receives HARQ ACK feedback for the initial transmission. For this blind transmission scenario, UE-B may wait for the report from UE-A for some (pre-) configured amount of time before the retransmission (e.g., of either the data TB per Options 1-1 or 2-1 or the dummy TB per Options 1-2 or 2-2).

In some cases, for Options 1-2 and 2-2, the dummy transmission may be replaced by a collection of some basic information obtained at UE B. As an example, a subset of the following set of information resources may be transmitted using a high reliability transmission scheme: the priority of the packet to be transmitted by UE-B, the remaining PDB of the corresponding packet, a number of sub-channels to be used for transmission of the packet, or the TB size for the next transmission. As an alternative, or in addition, the information may include a subset of the following set of information resources: the request for CSI report and the corresponding CSI-RS, the reliability requirement for the corresponding packet, the power control levels used by UE-B, the communication range requirements on the link from UE-B to UE-A, the cast type of communications for the packet, when UE-B is also sensing (at least partially), the set of available/unavailable resources, the request for a given number of reports with a given periodicity, if UE-B knows that UE-B will require more reports soon (e.g., based on a large buffer size or knowledge of new packet arrivals in the future). As an alternative, or in addition, the information may include a resource reservation interval, a start time of a resource selection window, or an end time of the resource selection window, or other data multiplexed in the first sidelink transmission.

UE-A may use such information in various ways. For example, UE-A may use the request information (e.g., via CSI estimation based on CSI-RS) for deciding a modulation and coding scheme (MCS) index, a number of sub-channels, and/or a number of layers to be assigned to the scheduled resources and/or the resources in the candidate set that it will report back. In some cases, UE-A may also keep the resources that UE-A will report within the remaining PDB of the packet to be sent by UE-B.

UE-B and UE-A may need to be in sync regarding particular reporting transmission instances. For example, for the various options described herein, UE-B and UE-A may be in agreement on where the report is to be transmitted. In some cases, the reporting location, in time, may depend on various considerations. For example, the reporting location in time may be a function of the resource used for PSSCH or PSFCH transmission with regards to UE-B's initial transmission of a TB and/or the periodic/aperiodic generation of the traffic. For example, for periodic traffic, there might be periodic reports that arrive at predefined instances, as a function of the initial transmission location and a period of the packet generation. In some cases, the location of the report(s) may be defined as a fixed distance/set of fixed distances to either PSSCH or PSFCH transmission.

### Example Wireless Communications Devices

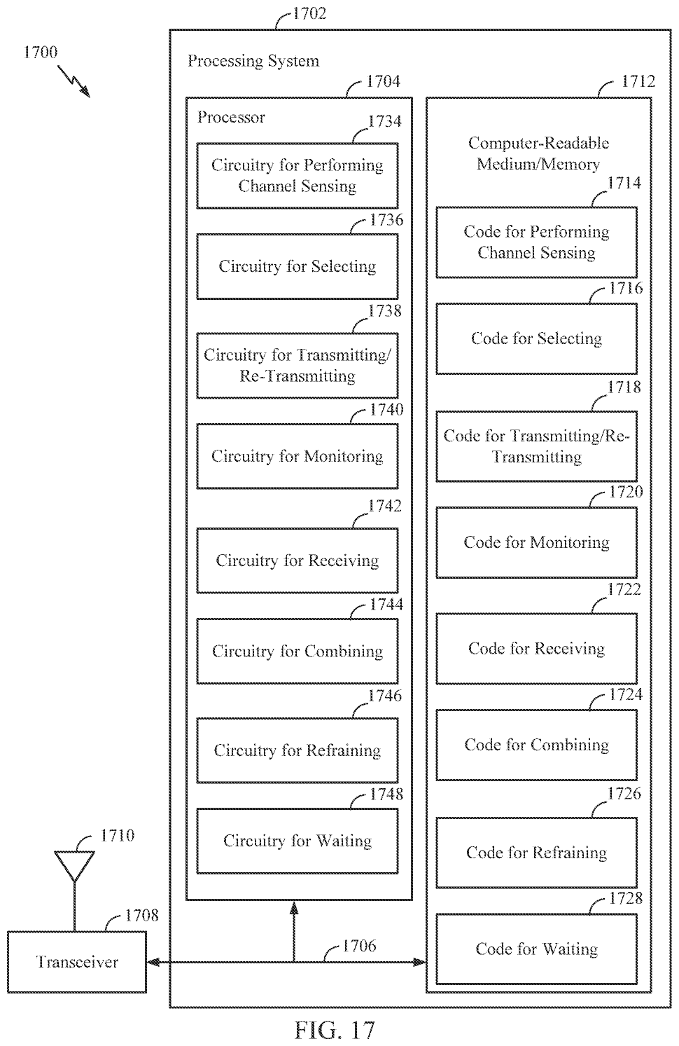

FIG. 17 illustrates a communications device 1700 that may include various components (e.g., corresponding to means-plus-function components) operable, configured, or adapted to perform operations for the techniques disclosed herein, such as operations 1400 illustrated in FIG. 14.

Communications device 1700 includes a processing system 1702 coupled to a transceiver 1708. Transceiver 1708 is configured to transmit and receive signals for communications device 1700 via an antenna 1710, such as the various signals as described herein. Processing system 1702 may be configured to perform processing functions for the communications device 1700, including processing signals received and/or to be transmitted by communications device 1700.

Processing system 1702 includes a processor 1704 coupled to a computer-readable medium/memory 1712 via a bus 1706. In certain aspects, computer-readable medium/memory 1712 is configured to store instructions (e.g., computer-executable code) that when executed by processor 1704, cause processor 1704 to perform the operations 1400 illustrated in FIG. 14, or other operations described herein.

In certain aspects, computer-readable medium/memory 1712 stores code 1714 for performing channel sensing, code 1716 for selecting, code 1718 for transmitting/re-transmitting, code 1720 for monitoring, code 1722 for receiving, code 1724 for combining, code 1726 for refraining, and code 1728 for waiting.

Examples of a computer-readable medium/memory 1712 include random access memory (RAM), read-only memory (ROM), solid state memory, a hard drive, a hard disk drive, etc. In some examples, computer-readable medium/memory 1712 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

In certain aspects, processor 1704 has circuitry configured to implement the code stored in computer-readable medium/memory 1712. Processor 1704 includes circuitry 1734 for performing channel sensing, circuitry 1736 for selecting, circuitry 1738 for transmitting/re-transmitting, circuitry 1740 for monitoring, circuitry 1742 for receiving, circuitry 1744 for combining, circuitry 1746 for refraining, and circuitry 1748 for waiting.

Various components of communications device 1700 may provide means for performing the methods described herein, including with respect to FIG. 14.

In some examples, means for delivering, transmitting/re-transmitting, or sending (or means for outputting for transmission/re-transmission) may include transceivers 454 and/or antenna(s) 452 of UE 120a illustrated in FIG. 4 and/or transceiver 1708 and antenna 1710 of communications device 1700 illustrated in FIG. 17.

In some examples, means for communicating or receiving (or means for obtaining) may include transceivers 454 and/or antenna(s) 452 of UE 120a illustrated in FIG. 4 and/or transceiver 1708 and antenna 1710 of communications device 1700 illustrated in FIG. 17.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 4.

In some examples, means for performing channel sensing, means for selecting, means for monitoring, means for combining, means for refraining, and means for waiting may include various processing system components, such as: the one or more processors 1704 in FIG. 17, or aspects of UE 120a depicted in FIG. 4, including receive processor 458, transmit processor 464, TX MIMO processor 466, and/or controller/processor 480 (including sidelink manager 481).

Notably, FIG. 17 is just one use example, and many other examples and configurations of communications device 1700 are possible.

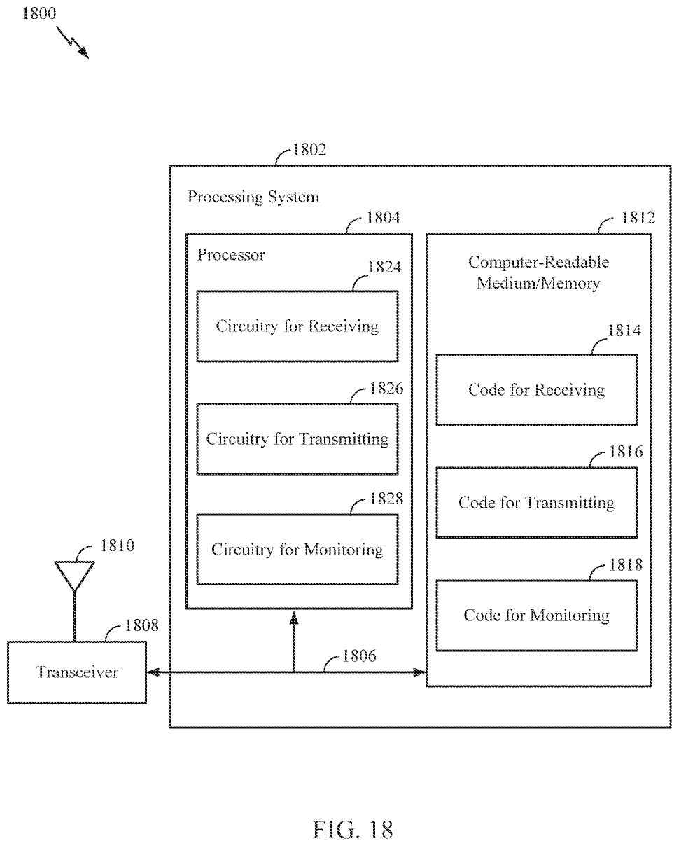

FIG. 18 illustrates a communications device 1800 that may include various components (e.g., corresponding to means-plus-function components) operable, configured, or adapted to perform operations for the techniques disclosed herein, such as the operations 1500 illustrated in FIG. 15.

Communications device 1800 includes a processing system 1802 coupled to a transceiver 1808. Transceiver 1808 is configured to transmit and receive signals for communications device 1800 via an antenna 1810, such as the various signals as described herein. Processing system 1802 may be configured to perform processing functions for communications device 1800, including processing signals received and/or to be transmitted by communications device 1800.

Processing system 1802 includes a processor 1804 coupled to a computer-readable medium/memory 1812 via a bus 1806. In certain aspects, computer-readable medium/memory 1812 is configured to store instructions (e.g., computer-executable code) that when executed by processor 1804, cause processor 1804 to perform operations 1500 illustrated in FIG. 15, or other operations described herein.

In certain aspects, computer-readable medium/memory 1812 stores code 1814 for receiving, code 1816 for transmitting, and code 1818 for monitoring.

Examples of a computer-readable medium/memory 1812 include RAM, ROM, solid state memory, a hard drive, a hard disk drive, etc. In some examples, computer-readable medium/memory 1812 is used to store computer-readable, computer-executable software including instructions that, when executed, cause a processor to perform various functions described herein. In some cases, the memory contains, among other things, a BIOS which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

In certain aspects, processor 1804 has circuitry configured to implement the code stored in computer-readable medium/memory 1812. Processor 1804 includes circuitry 1824 for receiving, circuitry 1826 for transmitting, and circuitry 1828 for monitoring.

Various components of communications device 1800 may provide means for performing the methods described herein, including with respect to FIG. 15.

In some examples, means for delivering, transmitting/re-transmitting, or sending (or means for outputting for transmission/re-transmission) may include transceivers 454 and/or antenna(s) 452 of UE 120a illustrated in FIG. 4 and/or transceiver 1808 and antenna 1810 of communications device 1800 illustrated in FIG. 18.

In some examples, means for communicating or receiving (or means for obtaining) may include transceivers 454 and/or antenna(s) 452 of UE 120a illustrated in FIG. 4 and/or transceiver 1808 and antenna 1810 of communications device 1800 illustrated in FIG. 18.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 4.

In some examples, means for monitoring may include various processing system components, such as: the one or more processors 1820 in FIG. 18, or aspects of UE 120a depicted in FIG. 4, including receive processor 458, transmit processor 464, TX MIMO processor 466, and/or controller/processor 480 (including sidelink manager 481).

Notably, FIG. 18 is just one use example, and many other examples and configurations of communications device 1800 are possible.

### Example Aspects

Aspect 1: A method for wireless communications by a first user equipment (UE), comprising: sending a first sidelink transmission to at least one second UE to trigger the second UE to transmit a report regarding sidelink resource availability; and monitoring for a second sidelink transmission from the second UE after sending the first sidelink transmission.
Aspect 2: The method of Aspect 1, wherein the first UE sends the first sidelink transmission on a slot without channel sensing.
Aspect 3: The method of Aspect 2, further comprising randomly selecting the slot from a set of slots.
Aspect 4: The method of any one of Aspects 1-3, further comprising performing channel sensing for one or more slots prior to sending the first sidelink transmission.
Aspect 5: The method of Aspect 4, further comprising: receiving the report; combining information gathered from the channel sensing with information in the report; and selecting one or more resources for a subsequent sidelink transmission based on the combined information.
Aspect 6: The method of any one of Aspects 1-5, wherein the first UE sends the first sidelink transmission on a same number of subchannels as used when transmitting a physical sidelink shared channel (PSSCH) transmission.
Aspect 7: The method of any one of Aspects 1-6, wherein: the first sidelink transmission comprises an initial transmission of a transport block (TB); and the second sidelink transmission comprises a physical sidelink feedback channel (PSFCH) with an acknowledgment feedback regarding whether the first sidelink transmission is received by the second UE.
Aspect 8: The method of Aspect 7, further comprising: if the acknowledgement feedback indicates a successful reception of the first sidelink transmission, refraining from any further transmission of the same TB.
Aspect 9: The method of Aspect 7, wherein: if the acknowledgement feedback indicates a successful reception of the first sidelink transmission, waiting for a subsequent sidelink transmission of the report from the second UE.
Aspect 10: The method of Aspect 7, further comprising, if the acknowledgement feedback indicates an unsuccessful reception of the first sidelink transmission: waiting for the a subsequent sidelink transmission of the report from the second UE; and based on the report, re-transmitting the TB on one or more resources scheduled by the second UE or determined, by the first UE, based on the report.
Aspect 11: The method of Aspect 7, further comprising, if the first UE does not receive the PSFCH: waiting for the report being expected to arrive before a deadline.
Aspect 12: The method of Aspect 11, further comprising re-transmitting the TB after the deadline if the report is not received.
Aspect 13: The method of any one of Aspects 1-12, wherein the first UE sends the first sidelink transmission on a reduced number of subchannels relative to a number of subchannels used when transmitting a physical sidelink shared channel (PSSCH) transmission.
Aspect 14: The method of any one of Aspects 1-13, further comprising: receiving the report; and transmitting or re-transmitting a transport block (TB) on resources scheduled by the second UE or selected, by the first UE, based on the report.
Aspect 15: The method of any one of Aspects 1-13, further comprising, if the first UE does not receive an acknowledgement feedback regarding whether the first sidelink transmission is received by the second UE: waiting for the report being expected to arrive before a deadline.
Aspect 16: The method of Aspect 15, further comprising re-transmitting the first sidelink transmission after the deadline if the report is not received.
Aspect 17: The method of any one of Aspects 1-16, further comprising re-transmitting the first sidelink transmission until the first UE receives an acknowledgement feedback, the first UE receives the report, or a packet delay budget (PDB) is reached.
Aspect 18: The method of any one of Aspects 1-17, further comprising re-transmitting the first sidelink transmission if the report is not received within an amount of time after the transmission of the first sidelink transmission.
Aspect 19: The method of any one of Aspects 1-18, wherein the first sidelink transmission conveys information comprising at least one of: a priority of a packet to be transmitted by the first UE, a remaining packet delay budget (PDB) of a corresponding packet, a transport block (TB) size of a subsequent transmission from the first UE, a request for a channel state information (CSI) report and corresponding CSI-RS, a reliability requirement for a corresponding packet, power control levels used by the first UE, a communication range requirements on the link from the first UE to the second UE, a cast type of communications for a packet, or a set of resources based on channel sensing by the first UE.
Aspect 20: The method of any one of Aspects 1-19, further comprising receiving the report on time resources determined as a function of at least one of: a resource used for physical sidelink shared channel (PSSCH) or physical sidelink feedback channel (PSFCH) transmissions based on the first sidelink transmission; a periodic or an aperiodic generation of traffic; or a relative distance or distances from the resource used for the PSSCH or PSFCH transmissions.
Aspect 21: A method for wireless communications by a second user equipment (UE), comprising: receiving a first sidelink transmission from a first UE to trigger the second UE to transmit a report regarding sidelink resource availability; and transmitting the report in response to the reception of the first sidelink transmission.
Aspect 22: The method of Aspect 21, wherein the second UE receives the first sidelink transmission on a same number of subchannels as used when receiving a physical sidelink shared channel (PSSCH) transmission.
Aspect 23: The method of any one of Aspects 21-22, further comprising, prior to transmitting the report: transmitting a second sidelink transmission to the first UE comprises a physical sidelink feedback channel (PSFCH) with an acknowledgment feedback regarding whether the first sidelink transmission was received by the second UE.
Aspect 24: The method of Aspect 23, further comprising: if the acknowledgement feedback indicates a successful reception of the first sidelink transmission, sending the report to the first UE in a subsequent sidelink transmission.
Aspect 25: The method of Aspect 23, if the acknowledgement feedback indicates an unsuccessful reception of the first sidelink transmission: wherein the second UE transmitted the report to the first UE in a subsequent sidelink transmission; and the method further comprising monitoring for a retransmission of the first sidelink transmission.
Aspect 26: The method of any one of Aspects 21-25, wherein the second UE receives the first sidelink transmission on a reduced number of subchannels relative to a number of subchannels used when receiving a physical sidelink shared channel (PSSCH) transmission.
Aspect 27: The method of any one of Aspects 21-26, wherein the first sidelink transmission conveys information comprising at least one of: a priority of a packet to be transmitted by the first UE, a remaining packet delay budget (PDB) of a corresponding packet, a transport block (TB) size of a subsequent transmission from the first UE, a request for a channel state information (CSI) report and corresponding CSI-RS, a reliability requirement for a corresponding packet, power control levels used by the first UE, a communication range requirements on the link from the first UE to the second UE, a cast type of communications for a packet, or a set of resources based on channel sensing by the first UE.
Aspect 28: The method of Aspect 27, wherein the report includes one or more transmission parameters to be applied to resources indicated in the report, based on the information conveyed in the first sidelink transmission.
Aspect 29: The method of any one of Aspects 21-28, wherein: the first sidelink transmission conveys a remaining packet delay budget (PDB) of a corresponding packet to be transmitted by the first UE; and the report indicates one or more resources within the remaining PDB.
Aspect 30: The method of any one of Aspects 21-29, wherein the report is transmitted on time resources determined as a function of at least one of: a resource used for physical sidelink shared channel (PSSCH) or physical sidelink feedback channel (PSFCH) transmissions based on the first sidelink transmission; a periodic or an aperiodic generation of traffic; or a relative distance or distances from the resource used for the PSSCH or PSFCH transmissions.
Aspect 31: A first UE, comprising means for performing the operations of one or more of Aspects 1-20.
Aspect 32: A first UE, comprising a transceiver and a processing system including at least one processor configured to perform the operations of one or more of Aspects 1-20.
Aspect 33: An apparatus for wireless communications by a first user equipment, comprising: an interface configured to output a first sidelink transmission, for transmission, to at least one second UE to trigger the second UE to transmit a report regarding sidelink resource availability; and a processing system configured to monitor for a second sidelink transmission from the second UE after sending the first sidelink transmission.
Aspect 34: A computer-readable medium for wireless communications, comprising codes executable by an apparatus to: output a first sidelink transmission, for transmission, to at least one second UE to trigger the second UE to transmit a report regarding sidelink resource availability; and monitor for a second sidelink transmission from the second UE after sending the first sidelink transmission.
Aspect 35: A second UE, comprising means for performing the operations of one or more of Aspects 21-30.
Aspect 36: A second UE, comprising a transceiver and a processing system including at least one processor configured to perform the operations of one or more of Aspects 21-30.
Aspect 37: An apparatus for wireless communications by a second user equipment, comprising: an interface configured to obtain a first sidelink transmission from a first UE to trigger the second UE to transmit a report regarding sidelink resource availability, and output the report, for transmission, in response to the reception of the first sidelink transmission.
Aspect 38: A computer-readable medium for wireless communications, comprising codes executable by an apparatus to: obtain a first sidelink transmission from a first UE to trigger the second UE to transmit a report regarding sidelink resource availability, and output the report, for transmission, in response to the reception of the first sidelink transmission.

### ADDITIONAL CONSIDERATIONS

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 14 and 15 may be performed by various processors shown in FIG. 4, such as processors 466, 458, 464, and/or controller/processor 480 of the UE 120a (and/or UE 120b of FIG. 1).

Means for receiving may include a transceiver, a receiver or at least one antenna and at least one receive processor illustrated in FIG. 4. Means for transmitting, means for re-transmitting, means for sending or means for outputting may include, a transceiver, a transmitter or at least one antenna and at least one transmit processor illustrated in FIG. 4. Means for monitoring, means for selecting, means for combining, means for randomly selecting, means for refraining, means for waiting, and means for performing may include a processing system, which may include one or more processors, such as processors 458, 464 and 466, and/or controller/processor 480 of the UE 120a and/or processors 420, 430, 438, and/or controller/processor 440 of the BS 110a shown in FIG. 4.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing operations 1400 and 1500 described herein and illustrated in FIGS. 14 and 15, respectively.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A first user (UE) equipment configured for wireless communications, comprising: one or more memories comprising processor-executable instructions; and one or more processors configured to execute the processor-executable instructions and cause the first UE to:
receive, from a second UE, a first sidelink transmission requesting a report on sidelink resource availability;
determine one or more available sidelink resources based on sensing one or more slots;
generate the report comprising an indication of the determined available sidelink resources; and
transmit the report to the second UE.

2. The first UE of claim 1, wherein to determine the available sidelink resources comprises to:
decode one or more sidelink control information (SCI) messages in the one or more slots;
determine sidelink resource reservations based on the decoded one or more SCIs; and
determine the available sidelink resources based on excluding the determined sidelink resource reservations.

3. The first UE of claim 2, wherein to determine the available sidelink resources further comprises to exclude sidelink resources based on received signal levels.

4. The first UE of claim 1, wherein:
the first sidelink transmission is received on a resource of a first dedicated resource pool configured for receiving report requests, and
to transmit the report comprises to transmit the report on a resource of a second dedicated resource pool configured for transmitting reports.

5. The first UE of claim 1, wherein the indication of the determined available resources comprises, for each of a plurality of sidelink resources, a binary indicator of whether the sidelink resource is available.

6. The first UE of claim 1, wherein the report further indicates a subset of the available sidelink resources preferred by the first UE.

7. The first UE of claim 1, wherein to receive the first sidelink transmission comprises to receive a medium access control (MAC) control element or sidelink control information.

8. The first UE of claim 1, wherein the one or more processors are configured to execute the processor-executable instructions and further cause the first UE to trigger an aperiodic report comprising the indication of the determined available sidelink resources to be transmitted to the second UE upon receipt of the first sidelink transmission.

9. The first UE of claim 1, wherein the one or more processors are configured to execute the processor-executable instructions and further cause the first UE to receive a configuration for periodic reporting, wherein the report is transmitted according to the configuration.

10. The first UE of claim 1, wherein the one or more processors are configured to execute the processor-executable instructions and further cause the first UE to:
receive a failed sidelink transmission prior to receiving the first sidelink transmission; and
monitor for a retransmission of the failed sidelink transmission, wherein the first sidelink transmission comprises the retransmission.

11. The first UE of claim 1, wherein the one or more processors are configured to execute the processor-executable instructions and further cause the first UE to transmit an acknowledgement or negative acknowledgement of the first sidelink transmission over a physical sidelink feedback channel.

12. The first UE of claim 1, wherein the one or more processors are configured to execute the processor-executable instructions and further cause the first UE to detect a retransmission from the second UE on one or more resources indicated as available in the report.

13. The first UE of claim 1, wherein to transmit the report comprises to transmit the report over reserved reporting resources.

14. The first UE of claim 1, wherein the indication of available resources comprises channel quality measurements associated with the available resources.

15. The first UE of claim 1, wherein:
the first sidelink transmission indicates a communication range requirement, and
to determine available resources comprises to determine resources that satisfy the communication range requirement.

16. The first UE of claim 1, wherein:
the first sidelink transmission indicates a zone identifier, and
to determine available resources comprises to exclude resources reserved by UEs associated with the zone identifier.

17. The first UE of claim 1, wherein:
the first sidelink transmission indicates a reliability requirement, and
to determine available resources comprises to determine resources that satisfy the reliability requirement.

18. The first UE of claim 1, wherein:
the first sidelink transmission indicates a priority, and
to determine available resources comprises to determine the available resources further based on the priority.

19. The first UE of claim 1, wherein the one or more processors are configured to execute the processor-executable instructions and further cause the first UE to determine a modulation and coding scheme (MCS), number of sub-channels, or number of layers for the available sidelink resources based at least in part on information in the first sidelink transmission.

20. A method for wireless communication by a first user equipment (UE), comprising:
receiving, from a second UE, a first sidelink transmission requesting a report on sidelink resource availability;
determining one or more available sidelink resources based on sensing one or more slots;
generating the report comprising an indication of the determined available sidelink resources; and
transmitting the report to the second UE.
